(19) United States
(12) Patent Application Publication
(10) Pub. No.: US 2026/0031559 A1
(43) Pub. Date: Jan. 29, 2026

(54) CONNECTOR ASSEMBLY

(71) Applicant: Japan Aviation Electronics Industry, Ltd., Tokyo (JP)

(72) Inventor: Kenta Ashibu, Tokyo (JP)

(73) Assignee: Japan Aviation Electronics Industry, Ltd., Tokyo (JP)

(21) Appl. No.: 19/240,751

(22) Filed: Jun. 17, 2025

(30) Foreign Application Priority Data
Jul. 26, 2024 (JP) 2024-120685

(51) Int. Cl. H01R 12/71; H01R 12/70; H01R 13/24; H01R 13/629

(52) U.S. Cl. CPC H01R 12/716; H01R 12/707; H01R 13/2442; H01R 13/629

(57) ABSTRACT

A connector assembly that can improve contact reliability is provided. A connector assembly includes: a plug connector including a plurality of plug contacts and a plug housing holding the plurality of plug contacts, the plug connector being mountable on a plug side board; and a receptacle connector including a plurality of receptacle contacts and a receptacle housing holding the plurality of receptacle contacts, the receptacle connector being mountable on a receptacle side board, in which each of the receptacle contacts includes a guide part including a slit, and a contact part including at least one spring piece that is elastically deformed as each plug contact moves along the slit.

### INCORPORATION BY REFERENCE

This application is based upon and claims the benefit of priority from Japanese patent application No. 2024-120685, filed on Jul. 26, 2024, the disclosure of which is incorporated herein in its entirety by reference.

### BACKGROUND

The present disclosure relates to a connector assembly.

Patent Literature 1 discloses a board-to-board connector assembly. For example, a connector assembly as shown in FIG. 27 of the present application includes a signal pin 10 disposed in a plug connector and a terminal 11 disposed in a receptacle connector. The connector assembly shown in FIG. 27 causes the plug connector to slide relative to the receptacle connector to cause the plug connector to mate with the receptacle connector. Specifically, after a signal contact part 12 of the signal pin 10 is inserted into a wide part 13 of the terminal 11, the plug connector is slid relative to the receptacle connector in a direction parallel to a mounting surface of a board.
[Patent Literature 1] Japanese Unexamined Patent Application Publication No. 2019-129137

### SUMMARY

Since it is difficult to obtain a feeling of mating at the time of slide mating, it is possible that the plug connector and the receptacle connector may be half mated. Therefore, it is impossible to improve the contact reliability. The present disclosure has been made in order to solve the aforementioned problem, and an object of the present disclosure is to provide a connector assembly that can improve contact reliability.

According to an aspect of the present disclosure, a connector assembly includes: a plug connector including a plurality of plug contacts and a plug housing holding the plurality of plug contacts, the plug connector being mountable on a plug side board; and a receptacle connector including a plurality of receptacle contacts and a receptacle housing holding the plurality of receptacle contacts, the receptacle connector being mountable on a receptacle side board, in which the plug connector and the receptacle connector mate with each other, whereby the respective plug contacts and the respective receptacle contacts come into electrical contact with each other, each receptacle contact includes: a guide part including a slit extending in a first direction parallel to an arrangement plane in which the plurality of receptacle contacts are disposed; and a contact part that is disposed on one side of a second direction perpendicular to the arrangement plane relative to the guide part, the contact part including at least one spring piece that is elastically deformed as each plug contact moves in the first direction along the slit, and the at least one spring piece comes into contact with each plug contact that has moved to a predetermined mating position in the slit by a spring restoring force.

In the above connector assembly, the guide part may include a projecting part that narrows a width of the slit formed in the vicinity of the mating position in the slit.

In the above connector assembly, the at least one spring piece may be a cantilever beam.

In the above connector assembly, each receptacle contact may include: at least one leg part extending in the second direction from the guide part; and a mounting part that is connected to the leg part and can be soldered onto the receptacle side board.

In the above connector assembly, the at least one spring piece may include two spring pieces, and the two spring pieces: may be disposed in such a way that each plug contact that has moved to the mating position in the slit is inserted between the two spring pieces, and may come into contact with each plug contact that has moved to the mating position in the slit by a spring restoring force.

In the above connector assembly, the guide part may be in a U-shape having the slit extending in the first direction as seen from the second direction, each receptacle contact may include: at least one leg part extending in the second direction from one end part of the guide part in the first direction; and a mounting part that is connected to the leg part and can be soldered onto the receptacle side board, and the two spring pieces may extend like cantilever beams from another end part of the guide part in the first direction.

In the above connector assembly, the guide part may be in a U-shape having the slit extending in the first direction as seen from the second direction, each receptacle contact may further include: at least one first leg part extending in the second direction from one end part of the guide part in the first direction; a mounting part that is connected to the first leg part and can be soldered onto the receptacle side board; and at least one second leg part extending in the second direction from another end part of the guide part in the first direction, and the two spring pieces may extend like cantilever beams from the second leg part.

In the above connector assembly, the guide part may be in a U-shape having the slit extending in the first direction as seen from the second direction, each receptacle contact may include: at least one leg part extending in the second direction from one end part of the guide part in the first direction; and a mounting part that is connected to the leg part and can be soldered onto the receptacle side board, and the two spring pieces may extend like cantilever beams from one end part and another end part of the guide part in a third direction perpendicular to the first direction and the second direction.

In the above connector assembly, the guide part may be in a U-shape having the slit extending in the first direction as seen from the second direction, each receptacle contact may include: at least one leg part extending in the second direction from one end part of the guide part in the first direction; and a mounting part that is connected to the leg part and can be soldered onto the receptacle side board, and the two spring pieces may extend like cantilever beams from the leg part.

According to the present disclosure, it is possible to improve contact reliability.

The above and other objects, features and advantages of the present disclosure will become more fully understood from the detailed description given hereinbelow and the accompanying drawings.

### BRIEF DESCRIPTION OF DRAWINGS

FIG. 1 is a perspective view illustrating a plug connector and a receptacle connector before they mate with each other in a connector assembly according to a first embodiment;

FIG. 2 is a side view illustrating the plug connector in the connector assembly according to the first embodiment;

FIG. 3 is a cross-sectional view illustrating the plug connector in the connector assembly according to the first embodiment, and shows a cross section taken along the line III-III of FIG. 2;

FIG. 4 is a side view illustrating the receptacle connector in the connector assembly according to the first embodiment;

FIG. 5 is a cross-sectional view illustrating the receptacle connector in the connector assembly according to the first embodiment, and shows a cross section taken along the line V-V of FIG. 4;

FIG. 6 is a perspective view illustrating the plug connector and the receptacle connector after they mate with each other in the connector assembly according to the first embodiment;

FIG. 7 is a side view illustrating the plug connector and the receptacle connector after they mate with each other in the connector assembly according to the first embodiment;

FIG. 8 is a cross-sectional view illustrating the plug contact and the receptacle contact after they mate with each other in the connector assembly according to the first embodiment, and shows a cross section taken along the line VIII-VIII in FIG. 7;

FIG. 9 is a perspective view illustrating a plug connector mounted on a substrate in the connector assembly according to the first embodiment;

FIG. 10 is a perspective view illustrating the receptacle connector mounted on the substrate in the connector assembly according to the first embodiment;

FIG. 11 is a perspective view illustrating the plug contact and the receptacle contact before they mate with each other in the connector assembly according to the first embodiment;

FIG. 12 is a side view illustrating the plug contact in the connector assembly according to the first embodiment;

FIG. 13 is a side view illustrating the plug contact in the connector assembly according to the first embodiment;

FIG. 14 is a plan view illustrating the plug contact in the connector assembly according to the first embodiment;

FIG. 15 is a partial cross-sectional view illustrating the receptacle contact in the connector assembly according to the first embodiment, and shows a partial cross-section taken along the line XV-XV in FIG. 17;

FIG. 16 is a side view illustrating the receptacle contact in the connector assembly according to the first embodiment;

FIG. 17 is a plan view illustrating the receptacle contact in the connector assembly according to the first embodiment;

FIG. 18 is a partial cross-sectional view illustrating the plug contact and the receptacle contact after they mate with each other in the connector assembly according to the first embodiment, and shows a cross section taken along the line XVIII-XVIII in FIG. 19;

FIG. 19 is a plan view illustrating the plug contact and the receptacle contact after they mate with each other in the connector assembly according to the first embodiment;

FIG. 20 is a partial cross-sectional view illustrating a mating operation between the plug contact and the receptacle contact in the connector assembly according to the first embodiment;

FIG. 21 is a partial cross-sectional view illustrating the mating operation between the plug contact and the receptacle contact in the connector assembly according to the first embodiment;

FIG. 22 is a perspective view illustrating the receptacle contact in a connector assembly according to a second embodiment;

FIG. 23 is a plan view illustrating the receptacle contact in the connector assembly according to the second embodiment;

FIG. 24 is a perspective view illustrating a receptacle contact in a connector assembly according to a third embodiment;

FIG. 25 is a perspective view illustrating a receptacle contact in a connector assembly according to a fourth embodiment;

FIG. 26 is a perspective view illustrating a receptacle contact in a connector assembly according to a fifth embodiment; and

FIG. 27 is a perspective view illustrating a board-to-board connector assembly.

### DESCRIPTION OF EMBODIMENTS

Hereinafter, with reference to the drawings, specific configurations of embodiments will be described. The following descriptions are given just to show preferred embodiments according to the present disclosure, and the scope of the present disclosure should not be limited to the embodiments described below. In the following explanations, components/structures to which the same symbols are assigned are substantially equivalent to each other. In order to prevent the drawings from being complicated, some reference symbols and some hatching may be omitted.

### First Embodiment

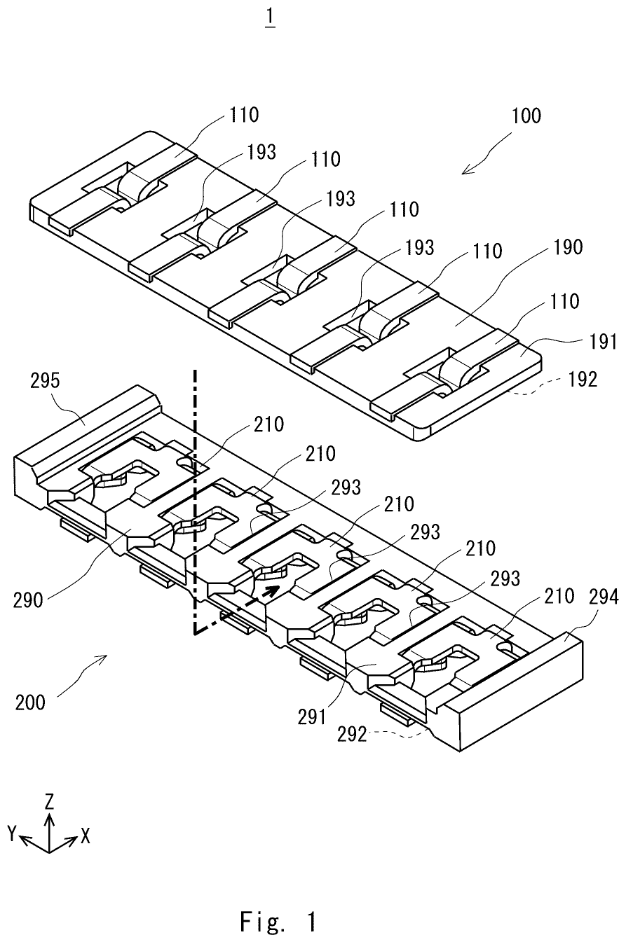

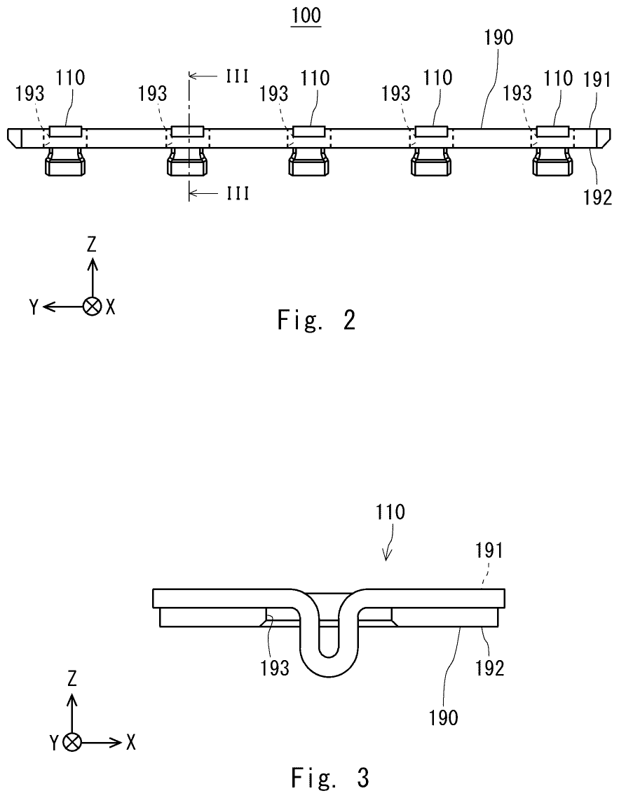

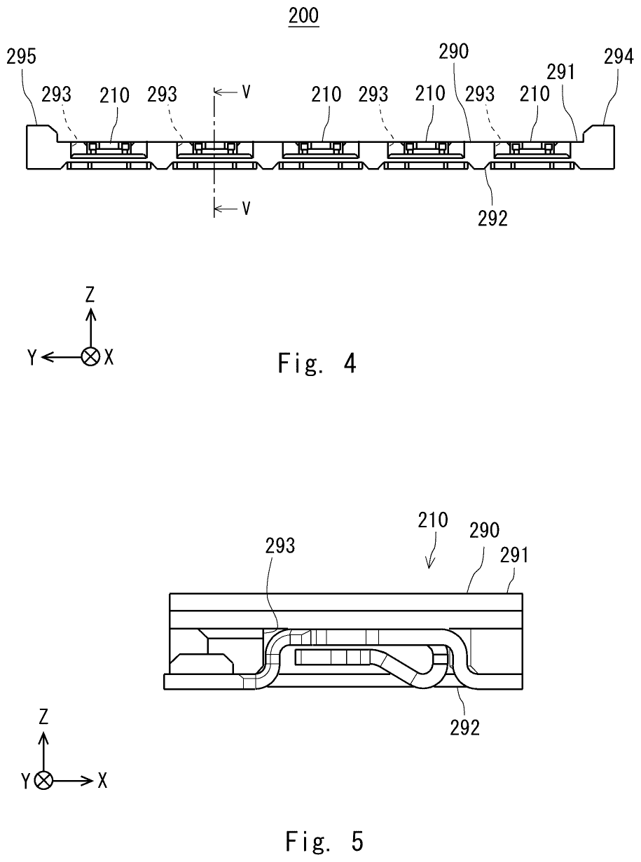

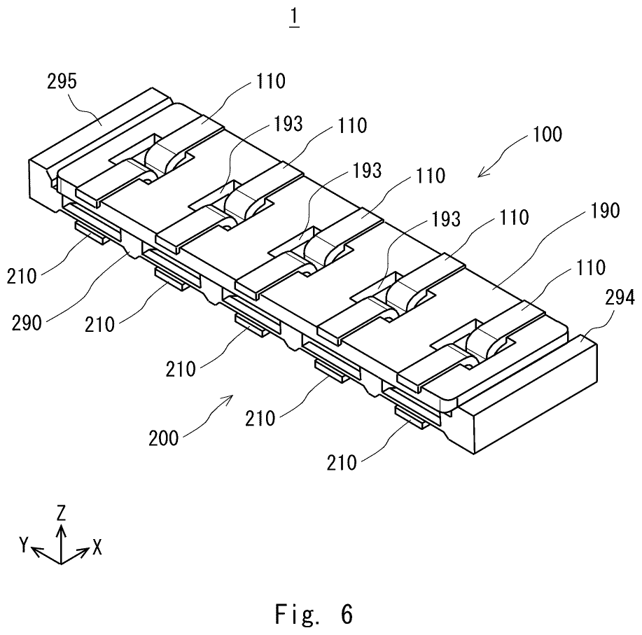

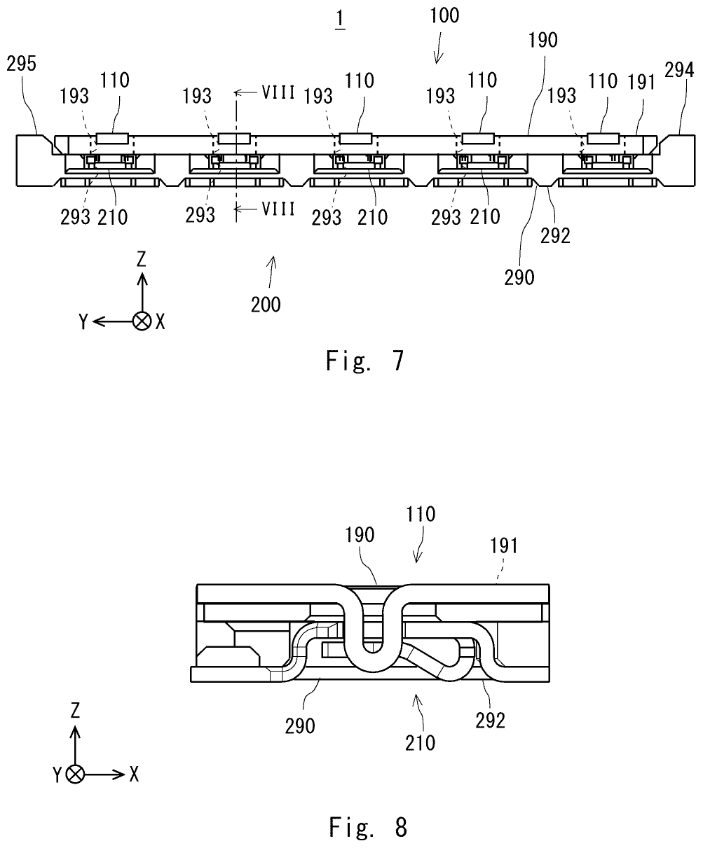

FIG. 1 is a perspective view illustrating a plug connector 100 and a receptacle connector 200 before they mate with each other in a connector assembly 1 according to a first embodiment. FIG. 2 is a side view illustrating the plug connector 100 in the connector assembly 1 according to the first embodiment. FIG. 3 is a cross-sectional view illustrating the plug contact 110 in the connector assembly 1 according to the first embodiment, and shows a cross section taken along the line III-III of FIG. 2. FIG. 4 is a side view illustrating the receptacle connector 200 in the connector assembly 1 according to the first embodiment. FIG. 5 is a cross-sectional view illustrating a receptacle contact 210 in the connector assembly 1 according to the first embodiment, and shows a cross section taken along the line V-V of FIG. 4. FIG. 6 is a perspective view illustrating the plug connector 100 and the receptacle connector 200 after they mate with each other in the connector assembly 1 according to the first embodiment. FIG. 7 is a side view illustrating the plug connector 100 and the receptacle connector 200 after they mate with each other in the connector assembly 1 according to the first embodiment. FIG. 8 is a cross-sectional view illustrating the plug contact 110 and the receptacle contact 210 after they mate with each other in the connector assembly 1 according to the first embodiment, and shows a cross section taken along the line VIII-VIII of FIG. 7.

As shown in FIGS. 1-8, the connector assembly 1 includes the plug connector 100 and the receptacle connector 200. The plug connector 100 includes a plurality of plug contacts 110 and a plug housing 190 that holds the plurality of plug contacts 110. The receptacle connector 200 includes a plurality of receptacle contacts 210 and a receptacle housing 290 that holds the plurality of receptacle contacts 210. The connector assembly 1 causes the plug connector 100 to mate with the receptacle connector 200, thereby bringing the respective plug contacts 110 to come into electrical contact with the respective receptacle contacts 210.

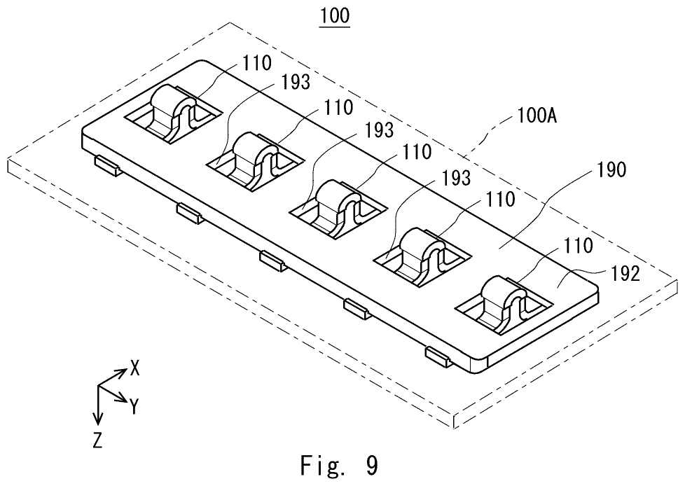

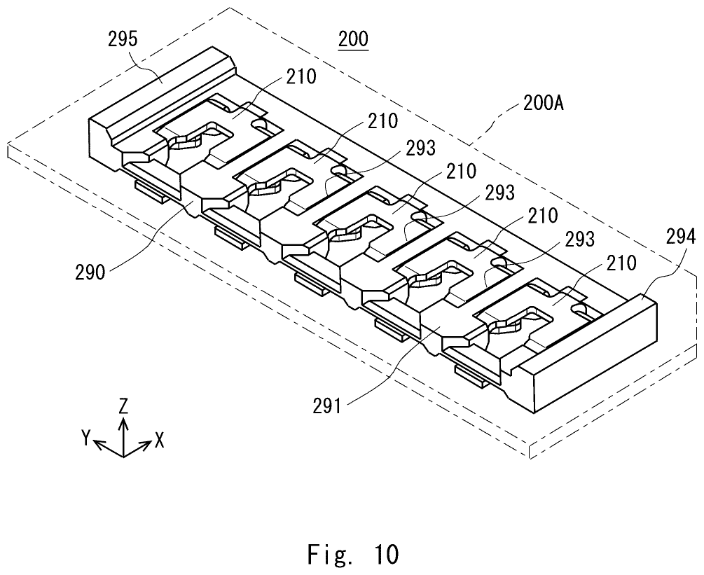

FIG. 9 is a perspective view illustrating the plug connector 100 mounted on a board 100A in the connector assembly 1 according to the first embodiment. FIG. 10 is a perspective view illustrating the receptacle connector 200 mounted on a board 200A in the connector assembly 1 according to the first embodiment. As shown in FIGS. 9 and 10, the connector assembly 1 may further include the board 100A and the board 200A. The plug connector 100 can be mountable on the board 100A. The receptacle connector 200 can be mountable on the board 200A. The board 100A may be referred to as a plug side board and the board 200A may be referred to as a receptacle side board. Note that the connector assembly 1 may not include the board 100A and the board 200A. The plug connector 100 and the receptacle connector 200 that mate with each other are opposed to each other.

For the sake of making the describing of the connector assembly 1 clear, an XYZ orthogonal coordinate axis system is introduced. For example, a plane parallel to a plane in which the plurality of plug contacts 110 are disposed in the plug housing 190 is defined to be an XY-plane. The plane in which the plurality of plug contacts 110 are disposed may be referred to as an arrangement plane. The direction in which the plug connector 100 and the receptacle connector 200 mated with each other are opposed to each other is defined to be a Z-axis direction.

The plug connector 100 that mates with the receptacle connector 200 is located on the Z-axis positive direction side of the receptacle connector 200. The receptacle connector 200 that mates with the plug connector 100 is located on the Z-axis negative direction side of the plug connector 100. When the plug connector 100 is mounted on the board 100A, the plug connector 100 may be mounted on the Z-axis negative direction side of the board 100A. When the receptacle connector 200 is mounted on the board 200A, the receptacle connector 200 may be mounted on the Z-axis positive direction side of the board 200A. The connector assembly 1 may be a board-to-board connector that mechanically and electrically connects the board 100A and the board 200A. Therefore, the connector assembly 1 may include the plug connector 100 mounted on the board 100A and the receptacle connector 200 mounted on the board 200A.

The plug housing 190 contains an insulator. The plug housing 190 contains, for example, resin. It is sufficient that the plug housing 190 contain an insulator, and may contain materials other than resin. The plug housing 190 may have, for example, a plate shape. The plug housing 190 may have, for example, a rectangular plate surface having sides extending in the X-axis direction and the Y-axis direction, as seen from the Z-axis direction.

Note that the plug housing 190 may have a shape other than a plate shape having a rectangular plate surface as long as the plug housing 190 can hold the plurality of plug contacts 110. The plug housing 190 may include a first surface 191 and a second surface 192. The second surface 192 is a surface which is opposite to the first surface 191. The first surface 191 is a surface on the Z-axis positive direction side relative to the second surface 192, and the second surface 192 is a surface on the Z-axis negative direction side relative to the first surface 191.

The plug housing 190 may include a plurality of holes 193. The holes 193 penetrate from the first surface 191 to the second surface 192. The plurality of holes 193 are formed, for example, to be aligned in the Y-axis direction. In another example, of the plurality of holes 193, a predetermined number of holes 193 may be aligned in the Y-axis direction. Further alternatively, some of the plurality of holes 193 may be aligned in a direction other than the Y-axis direction. For example, some of the holes 193 may be aligned in the X-axis direction on the XY-plane, or may be aligned to be tilted in the X-axis direction and the Y-axis direction.

The plurality of plug contacts 110 are disposed on the arrangement plane parallel to the XY-plane in the plug housing 190. For example, the plurality of plug contacts 110 are disposed in the holes 193. Accordingly, the plurality of plug contacts 110 are aligned in the Y-axis direction.

Of the plurality of plug contacts 110, a predetermined number of plug contacts 110 may be disposed in the Y-axis direction. Some of the plurality of plug contacts 110 may be aligned in a direction other than the Y-axis direction. For example, some of the plug contacts 110 may be aligned in the X-axis direction on the XY-plane, or may be aligned to be tilted in the X-axis direction and the Y-axis direction.

The receptacle housing 290 contains an insulator. The receptacle housing 290 may contain, for example, resin. It is sufficient that the receptacle housing 290 include an insulator, and the receptacle housing 290 may contain materials other than resin. The receptacle housing 290 may have, for example, a plate shape. The receptacle housing 290 may have, for example, a rectangular plate surface sides extending in the X-axis direction and the Y-axis direction as seen from the Z-axis direction. Note that the receptacle housing 290 may have a shape other than a plate shape having a rectangular plate surface as long as the receptacle housing 290 can hold the plurality of receptacle contacts 210. The receptacle housing 290 may include a first surface 291 and a second surface 292. The second surface 292 is a surface which is opposite to the first surface 291. The first surface 291 is a surface on the Z-axis positive direction side relative to the second surface 292, and the second surface 292 is a surface on the Z-axis negative direction side relative to the first surface 291.

The receptacle housing 290 may include a plurality of holes 293. The holes 293 penetrate from the first surface 291 to the second surface 292. The plurality of holes 293 are formed, for example, to be aligned in the Y-axis direction. In another example, of the plurality of holes 293, a predetermined number of holes 293 may be aligned in the Y-axis direction. Further alternatively, some of the plurality of holes 293 may be aligned in a direction other than in the Y-axis direction. For example, some of the holes 293 may be aligned in the X-axis direction on the XY-plane, or may be aligned to be tilted in the X-axis direction and the Y-axis direction.

A projecting part 294 and a projecting part 295 may be formed in end parts of the receptacle housing 290 in the Y-axis direction. The projecting part 294 is formed in the end part of the receptacle housing 290 in the Y-axis negative direction. The projecting part 295 is formed in the end part of the receptacle housing 290 in the Y-axis positive direction. The projecting part 294 and the projecting part 295 project in the Z-axis positive direction from the first surface 291. The projecting part 294 extends in the X-axis direction along the end part of the receptacle housing 290 in the Y-axis negative direction. The projecting part 295 extends in the X-axis direction along the end part of the receptacle housing 290 in the Y-axis positive direction.

When the plug connector 100 mates with the receptacle connector 200, the plug connector 100 is slid between the projecting part 294 and the projecting part 295 in the X-axis positive direction. At this time, the projecting part 294 and the projecting part 295 serve as guides that cause the both ends of the plug connector 100 in the Y-axis direction to be slid. When the plug connector 100 has mated with the receptacle connector 200, the plug connector 100 is disposed between the projecting part 294 and the projecting part 295. The projecting part 294 and the projecting part 295 sandwich the plug housing 190 of the plug connector 100 from the both sides in the Y-axis direction.

The plurality of receptacle contacts 210 are disposed on the arrangement plane parallel to the XY-plane in the receptacle housing 290. For example, the plurality of receptacle contacts 210 are disposed in the respective holes 293. Accordingly, the plurality of receptacle contacts 210 are aligned in the Y-axis direction. In another example, of the plurality of receptacle contacts 210, a predetermined number of receptacle contacts 210 may be aligned in the Y-axis direction. Further alternatively, some of the plurality of receptacle contacts 210 may be aligned in a direction other than the Y-axis direction. For example, some of the receptacle contacts 210 may be aligned in the X-axis direction on the XY-plane, or may be aligned to be tilted in the X-axis direction and the Y-axis direction.

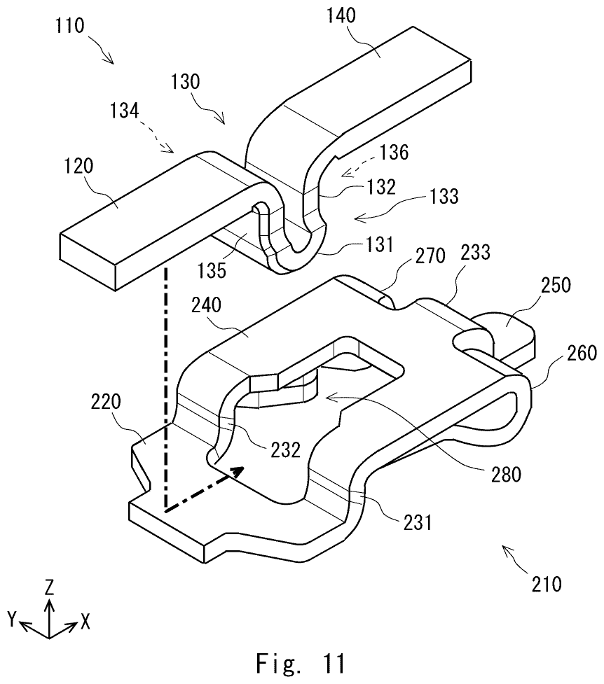

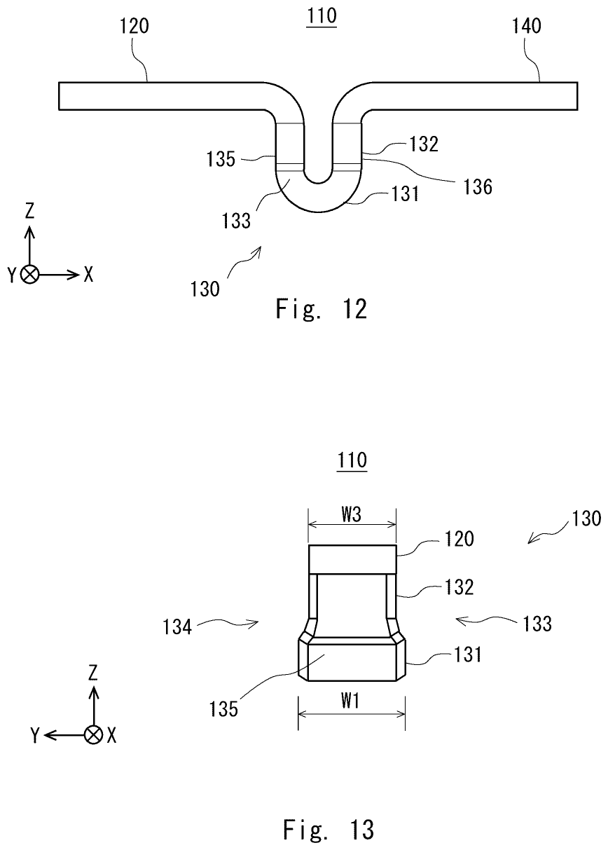

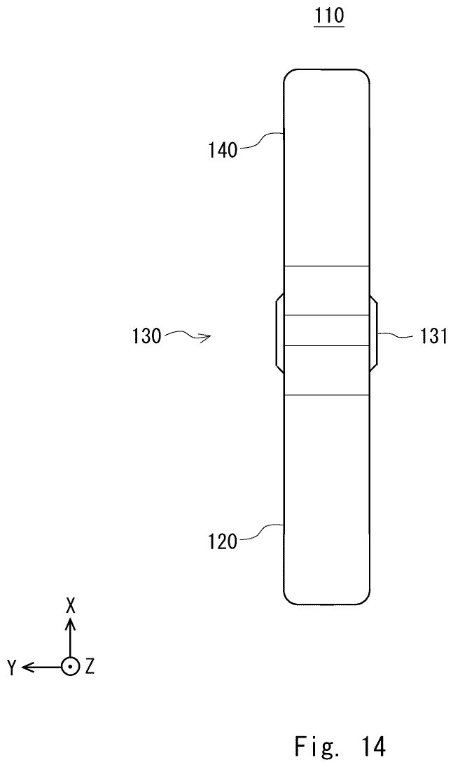

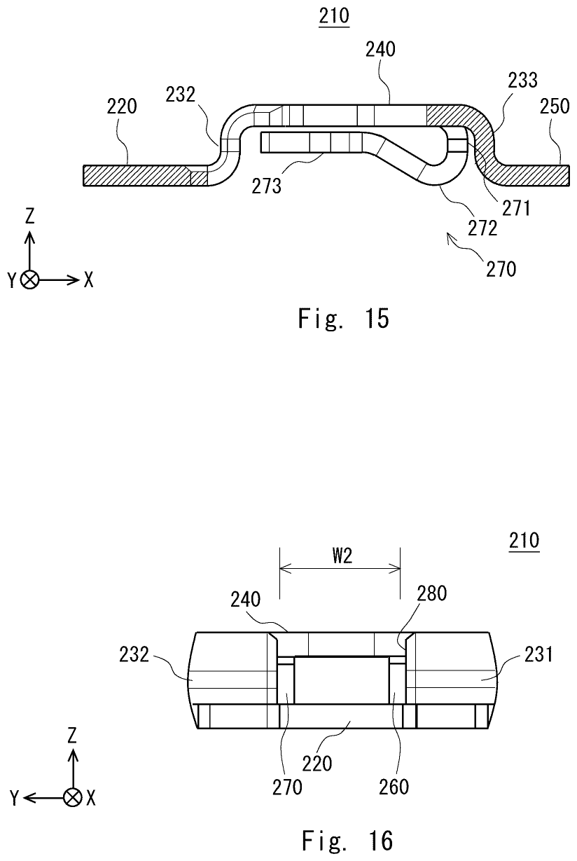

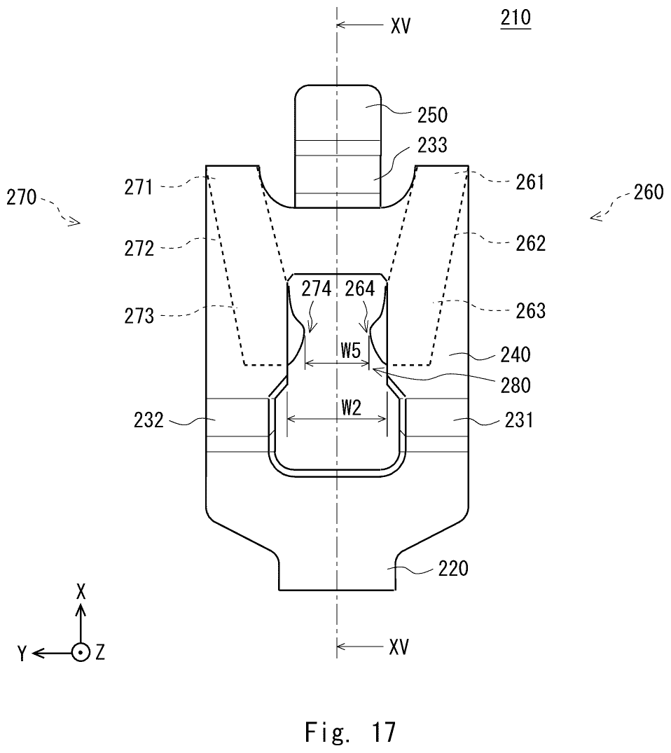

FIG. 11 is a perspective view illustrating the plug contact 110 and the receptacle contact 210 before they mate with each other in the connector assembly 1 according to the first embodiment. FIGS. 12 and 13 are side views illustrating the plug contact 110 in the connector assembly 1 according to the first embodiment. FIG. 14 is a plan view illustrating the plug contact 110 in the connector assembly 1 according to the first embodiment. FIG. 15 is a partial cross-sectional view illustrating the receptacle contact 210 in the connector assembly 1 according to the first embodiment, and shows a partial cross-section taken along the line XV-XV of FIG. 17. FIG. 16 is a side view illustrating the receptacle contact 210 in the connector assembly 1 according to the first embodiment. FIG. 17 is a plan view illustrating the receptacle contact 210 in the connector assembly 1 according to the first embodiment.

As shown in FIGS. 11-14, the plug contact 110 includes a mounting part 120, a projecting part 130, and a mounting part 140. The plug contact 110 contains a conductor. The plug contact 110 may contain, for example, metal. The plug contact 110 may be formed by punching and bending one metal plate. The metal plate is typically made of copper or copper alloy. Each plug contact 110 may preferably be plated by tin or the like before punching and bending or after punching and bending.

In this embodiment, the respective plug contacts 110 may be fixed to the respective holes 193 of the plug housing 190 by press-fitting, or may be fixed to the respective holes 193 by insert molding or using an adhesive. Further, the respective plug contacts 110 may be fastened to the respective holes 193, or another method may be used.

The mounting part 120 has a plate shape having a rectangular plate surface as seen from the Z-axis direction. The thickness direction of the mounting part 120 corresponds to the Z-axis direction. Therefore, the plate surface of the mounting part 120 is oriented in the Z-axis positive direction and the Z-axis negative direction. The end part on the X-axis negative direction side of the mounting part 120 may be exposed from an end side on the X-axis negative direction side of the plug housing 190. The mounting part 120 may be soldered onto an electrode, which is not shown, on the board 100A. The mounting part 120 is disposed on the first surface 191 of the plug housing 190. The mounting part 120 may be disposed in a groove formed on the first surface 191 of the plug housing 190.

The projecting part 130 is disposed between the mounting part 120 and the mounting part 140. Roughly speaking, the projecting part 130 is in a U-shape as seen from the Y-axis direction. The end part on the X-axis negative direction side of the U-shaped projecting part 130 is connected to the end part on the X-axis positive direction side of the mounting part 120. Therefore, the mounting part 120 and the projecting part 130 are connected to each other in an L shape as seen from the Y-axis direction. The projecting part 130 curves in a U-shape in such a way that it becomes convex toward the Z-axis negative direction.

The projecting part 130 may include a projection end part 131 and a projection root part 132. The projection end part 131 is a part on the Z-axis negative direction side of the projecting part 130. The projection root part 132 is a part on the Z-axis positive direction side of the projecting part 130. The projection root part 132 is located on the Z-axis positive direction side relative to the projection end part 131, and the projection end part 131 is located on the Z-axis negative direction side relative to the projection root part 132. A width W1 of the projection end part 131 in the Y-axis direction may be greater than a width W3 of the projection root part 132 in the Y-axis direction. Note that a case in which the width W1 of the projection end part 131 in the Y-axis direction has the same as the width W3 of the projection root part 132 in the Y-axis direction is not excluded.

The projecting part 130 includes a contact surface 133 oriented in the Y-axis negative direction, a contact surface 134 oriented in the Y-axis positive direction, a contact surface 135 oriented in the X-axis negative direction, and a contact surface 136 oriented in the X-axis positive direction. The projecting part 130 projects through the hole 193 of the plug housing 190 from the Z-axis positive direction side to the Z-axis negative direction side.

The mounting part 140 has a plate shape including a rectangular plate surface as seen from the Z-axis direction. The thickness direction of the mounting part 140 corresponds to the Z-axis direction. Therefore, the plate surface of the mounting part 140 is oriented in the Z-axis positive direction and the Z-axis negative direction. The end part on the X-axis negative direction side of the mounting part 140 is connected to the end part on the X-axis positive direction side of the U-shaped projecting part 130. Therefore, the mounting part 140 and the projecting part 130 are connected to each other in an L shape as seen from the Y-axis direction. The end part on the X-axis positive direction side of the mounting part 140 may be exposed from the end side on the X-axis positive direction side of the plug housing 190. The mounting part 140 may be soldered onto an electrode, which is not shown, on the board 100A, or may not be soldered onto this electrode. The mounting part 140 is disposed on the first surface 191 of the plug housing 190. The mounting part 140 may be disposed in a groove formed in the first surface 191 of the plug housing 190.

As shown in FIGS. 11 and 15-17, the receptacle contact 210 may include a mounting part 220, a leg part 231, a leg part 232, a leg part 233, a guide part 240, a mounting part 250, a contact part 260, and a contact part 270. The receptacle contact 210 contains a conductor. The receptacle contact 210 may contain, for example, metal. The receptacle contact 210 may be formed by punching and bending one metal plate. The metal plate is typically copper or copper alloy. Each receptacle contact 210 may be preferably plated by tin or the like before punching and bending or after punching and bending.

In this embodiment, the respective receptacle contacts 210 may be fixed to the respective holes 293 of the receptacle housing 290 by press-fitting or may be fixed to the respective holes 293 by insert molding or using an adhesive. Further, the respective receptacle contacts 210 may be fastened to the respective holes 293, or another method may be used.

The mounting part 220 is disposed on the X-axis negative direction side of the guide part 240. The mounting part 220 has a plate shape having a Y-shaped plate surface as seen from the Z-axis direction. The thickness direction of the mounting part 220 corresponds to the Z-axis direction. Therefore, the plate surface of the mounting part 220 is oriented in the Z-axis positive direction and the Z-axis negative direction. The end part on the X-axis negative direction side of the mounting part 220 may be exposed from the end side on the X-axis negative direction side of the receptacle housing 290. The mounting part 220 may be soldered onto an electrode, which is not shown, of the board 200A. As described above, the receptacle contact 210 includes the mounting part 220 that can be soldered onto the board 200A. The end parts on the X-axis positive direction side of the mounting part 220 are branched in a Y shape.

The leg part 231 and the leg part 232 are aligned in the Y-axis direction between the mounting part 220 and the guide part 240. The leg part 231 and the leg part 232 are connected to the end parts on the X-axis negative direction side of the guide part 240. Note that the receptacle contact 210 may include at least one of the leg part 231 or the leg part 232.

The leg part 231 includes a part extending in the Z-axis direction. The end part on the Z-axis negative direction side of the leg part 231 is connected to the branched end part on the Y-axis negative direction side of the mounting part 220. Therefore, the mounting part 220 and the leg part 231 are connected to each other in an L shape as seen from the Y-axis direction. The leg part 232 includes a part extending in the Z-axis direction. The end part on the Z-axis negative direction side of the leg part 232 is connected to the branched end part on the Y-axis positive direction side of the mounting part 220. Therefore, the mounting part 220 and the leg part 232 are connected to each other in an L shape as seen from the Y-axis direction. Therefore, the receptacle contact 210 includes the leg parts 231 and 232 that extend in the Z-axis direction from the end part on the X-axis negative direction side of the guide part 240 in the X-axis direction, and the mounting part 220 connected to the leg part 231 and the leg part 232.

Roughly speaking, the guide part 240 has a plate shape having a U-shaped plate surface as seen from the Z-axis direction. The thickness direction of the guide part 240 corresponds to the Z-axis direction. The opening of the U-shape of the guide part 240 faces the X-axis negative direction side. Therefore, the guide part 240 is in a U-shape having a slit 280 that extends in the X-axis direction as seen from the Z-axis direction. The end part on the Z-axis positive direction side of the leg part 231 is connected to the end part on the Y-axis negative direction and X-axis negative direction side of the guide part 240. Therefore, the leg part 231 and the guide part 240 are connected to each other in an L shape as seen from the Y-axis direction. The end part on the Z-axis positive direction side of the leg part 232 is connected to the end part on the Y-axis positive direction and X-axis negative direction side of the guide part 240. Therefore, the leg part 232 and the guide part 240 are connected to each other in an L shape as seen from the Y-axis direction.

The space in the opening of the Y-shape of the mounting part 220, the space between the leg part 231 and the leg part 232, and the space in the opening of the U-shape of the guide part 240 communicate with each other to form the slit 280. The slit 280 extends in the X-axis direction as seen from the Z-axis direction. As described above, the guide part 240 includes the slit 280 extending in the X-axis direction parallel to the arrangement plane where the plurality of receptacle contacts 210 are disposed.

The leg part 233 is disposed between the guide part 240 and the mounting part 250. The leg part 233 includes a part extending in the Z-axis direction. The end part on the Z-axis positive direction side of the leg part 233 is connected to the end part on the X-axis positive direction side of the guide part 240. Therefore, the guide part 240 and the leg part 233 are connected to each other in an L shape as seen from the Y-axis direction. As described above, the receptacle contact 210 includes the leg part 233 extending in the Z-axis direction from the end part on the X-axis positive direction side of the guide part 240 in the X-axis direction.

The mounting part 250 has a plate shape having a rectangular plate surface as seen from the Z-axis direction. The thickness direction of the mounting part 250 corresponds to the Z-axis direction. Therefore, the plate surface of the mounting part 250 is oriented in the Z-axis positive direction and the Z-axis negative direction. The end part on the X-axis negative direction side of the mounting part 250 is connected to the end part on the Z-axis negative direction side of the leg part 233. Therefore, the leg part 233 and the mounting part 250 are connected to each other in an L shape as seen from the Y-axis direction. The end part on the X-axis positive direction side of the mounting part 250 may be exposed from the end side on the X-axis positive direction side of the receptacle housing 290. The mounting part 250 may be soldered onto an electrode, which is not shown, of the board 200A or may not be soldered onto the electrode.

The contact part 260 and the contact part 270 are connected to the end part on the X-axis positive direction side of the guide part 240. The contact part 260 and the contact part 270 are disposed on the Z-axis negative direction side relative to the guide part 240. The contact part 260 is disposed on the Y-axis negative direction side relative to the contact part 270. The contact part 270 is disposed on the Y-axis positive direction side relative to the contact part 260. The contact part 260 and the contact part 270 are supported by the guide part 240 like cantilever beams.

The contact part 260 includes an extension part 261, a curve part 262, and an extension part 263. The contact part 270 includes an extension part 271, a curve part 272, and an extension part 273.

The extension part 261 includes a part extending in the Z-axis direction. The end part on the Z-axis positive direction side of the extension part 261 is connected to the end part on the X-axis positive direction side of the guide part 240. Therefore, the guide part 240 and the extension part 261 are connected to each other in an L shape as seen from the Y-axis direction. The extension part 261 is a part that extends in the Z-axis negative direction from the end part on the X-axis positive direction side of the guide part 240. The extension part 261 is disposed on the Z-axis negative direction side relative to the guide part 240. The end part on the Z-axis positive direction side of the extension part 261 is located on the Y-axis negative direction side of the leg part 233.

The curve part 262 includes a part that is curved and extends in the X-axis direction. The end part on the X-axis positive direction side of the curve part 262 is connected to the end part on the Z-axis negative direction side of the extension part 261. The curve part 262 is a part that extends in the X-axis negative direction from the end part on the Z-axis negative direction side of the extension part 261, and curves to be convex in the Z-axis negative direction. That is, the curve part 262 is in a U-shape that opens in the Z-axis positive direction. The curve part 262 is disposed on the Z-axis negative direction side relative to the guide part 240.

The extension part 263 includes a part extending in the X-axis direction. The end part on the X-axis positive direction side of the extension part 263 is connected to the end part on the X-axis negative direction side of the curve part 262. The extension part 263 is disposed on the Z-axis negative direction side relative to the guide part 240.

With the aforementioned configuration, the contact part 260 functions as a spring piece that is elastically deformed. Specifically, the contact part 260 that serves as a spring piece extends like a cantilever beam from the end part on the X-axis positive direction side of the guide part 240. The contact part 260 may be elastically deformed in the Y-axis direction using the end part of the extension part 261 in the Z-axis positive direction as a support. As described above, the contact part 260 includes a spring piece that is elastically deformed. The spring piece serves as a cantilever beam that uses the end part of the extension part 261 of the contact part 260 in the Z-axis positive direction as a support.

The extension part 271 includes a part extending in the Z-axis direction. The end part on the Z-axis positive direction side of the extension part 271 is connected to the end part on the X-axis positive direction side of the guide part 240. Therefore, the guide part 240 and the extension part 271 are connected to each other in an L shape as seen from the Y-axis direction. The extension part 271 is a part that extends downward from the end part on the X-axis positive direction side of the guide part 240. The extension part 271 is disposed on the Z-axis negative direction side relative to the guide part 240. The end part on the Z-axis positive direction side of the extension part 271 is located on the Y-axis positive direction side of the leg part 233. Therefore, the leg part 233 is located between the extension part 261 and the extension part 271 in the Y-axis direction.

The curve part 272 includes a part that is curved and extends in the X-axis direction. The end part on the X-axis positive direction side of the curve part 272 is connected to the end part on the Z-axis negative direction side of the extension part 271. The curve part 272, which is a part that extends in the X-axis negative direction from the end part on the Z-axis negative direction side of the extension part 271, curves to be convex in the Z-axis negative direction. That is, the curve part 272 is in a U-shape that opens in the Z-axis positive direction. The curve part 272 is disposed on the Z-axis negative direction side relative to the guide part 240.

The extension part 273 includes a part extending in the X-axis direction. The end part on the X-axis positive direction side of the extension part 273 is connected to the end part on the X-axis negative direction side of the curve part 272. The extension part 273 is disposed on the Z-axis negative direction side relative to the guide part 240.

With the aforementioned configuration, the contact part 270 functions as a spring piece that is elastically deformed. Specifically, the contact part 270 that functions as a spring piece extends like a cantilever beam from the end part on the X-axis positive direction side of the guide part 240. The contact part 270 may be elastically deformed in the Y-axis direction using the end part of the extension part 271 in the Z-axis positive direction as a support. As described above, the contact part 270 includes a spring piece that is elastically deformed. The spring piece serves as a cantilever beam that uses the end part of the extension part 271 in the contact part 270 in the Z-axis positive direction as a support.

The contact part 260 and the contact part 270 extend to come closer to each other toward the X-axis negative direction as seen from the Z-axis direction. The extension part 263 of the contact part 260 may include a projection part 264 projecting toward the extension part 273 of the contact part 270. Further, the extension part 273 of the contact part 270 may include a projecting part 274 projecting toward the extension part 263 of the contact part 260.

As described above, the width W1 of the projection end part 131 in the Y-axis direction may be greater than the width W3 of the projection root part 132 in the Y-axis direction.

That is, (the width W1 of the projection end part 131)>(the width W3 of the projection root part 132) is satisfied.

On the other hand, a width W2 of the slit 280 of the guide part 240 in the Y-axis direction is greater than the width W3 of the projection root part 132 in the Y-axis direction.

That is, (the width W2 of the slit 280)>(the width W3 of the projection root part 132) is satisfied.

The expression (the width W2 of the slit 280)>(the width W3 of the projection root part 132) may be satisfied so that the projection root part 132 can slidably move while contacting the edges of the slit 280 opposed to each other.

In the state before the mating of connector assembly 1, a width W5 between the projecting part 264 of the contact part 260 and the projecting part 274 of the contact part 270 in the Y-axis direction is smaller than the width W2 of the slit 280 of the guide part 240 in the Y-axis direction.

That is, (the width W2 of the slit 280)>(the width W5 between the projecting part 264 and the projecting part 274) is satisfied.

Accordingly, the projecting part 264 of the contact part 260 and the projecting part 274 of the contact part 270 can be visually recognized through the slit 280 as seen from the Z-axis direction.

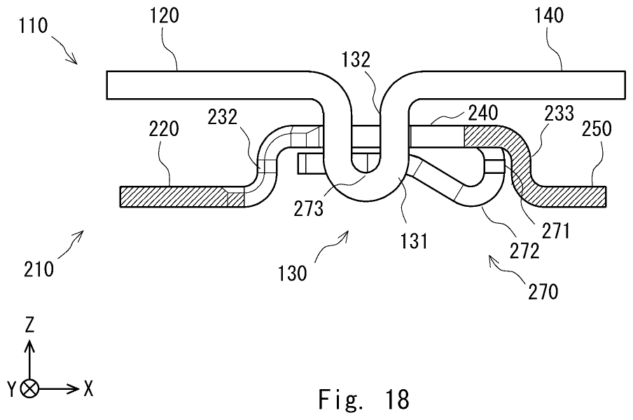

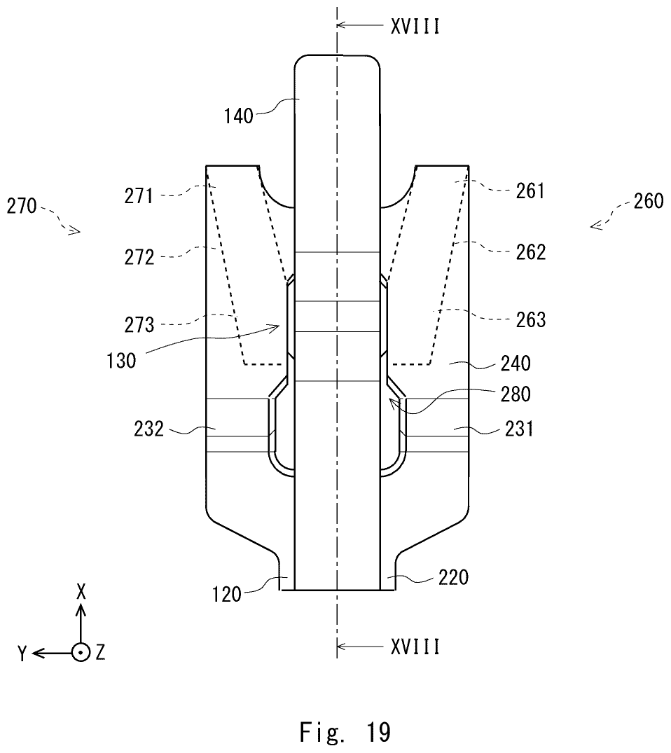

FIG. 18 is a partial cross-sectional view illustrating the plug contact 110 and the receptacle contact 210 after they mate with each other in the connector assembly 1 according to the first embodiment, and shows a cross section taken along the line XVIII-XVIII in FIG. 19. FIG. 19 is a plan view illustrating the plug contact 110 and the receptacle contact 210 after they mate with each other in the connector assembly 1 according to the first embodiment. As shown in FIGS. 18 and 19, when the plug contact 110 mates with the receptacle contact 210, the projecting part 130 of the plug contact 110 moves in the X-axis positive direction along the slit 280 of the guide part 240 of the receptacle contact 210.

The projection root part 132 of the projecting part 130 moves in the X-axis positive direction along the edges of the slit 280 opposed to each other in the Y-axis direction. On the other hand, the projection end part 131 of the projecting part 130 is inserted between the extension part 263 of the contact part 260 and the extension part 273 of the contact part 270. The contact part 260 and the contact part 270 are elastically deformed so as to expand on both sides of the Y-axis direction as the projection end part 131 moves in the X-axis positive direction. As described above, the contact part 260 and the contact part 270 each include a spring piece that is elastically deformed as the plug contact 110 moves in the X-axis positive direction along the slit 280. The two spring pieces come into contact with each plug contact 110 that has moved to a predetermined mating position in the slit 280 by a spring restoring force. The predetermined mating position may be, for example, a position where the projecting part 264 of the contact part 260 and the projecting part 274 of the contact part 270 are disposed in the center of the U shape of the projecting part 130.

In the above manner, each plug contact 110 that has moved to the mating position in the slit 280 is inserted between two spring pieces of the contact part 260 and the contact part 270. Note that, in the receptacle contact 210, at least one spring piece of the contact part 260 and the contact part 270 may come into contact with each plug contact 110 that has moved to the mating position in the slit 280 according to a spring restoring force.

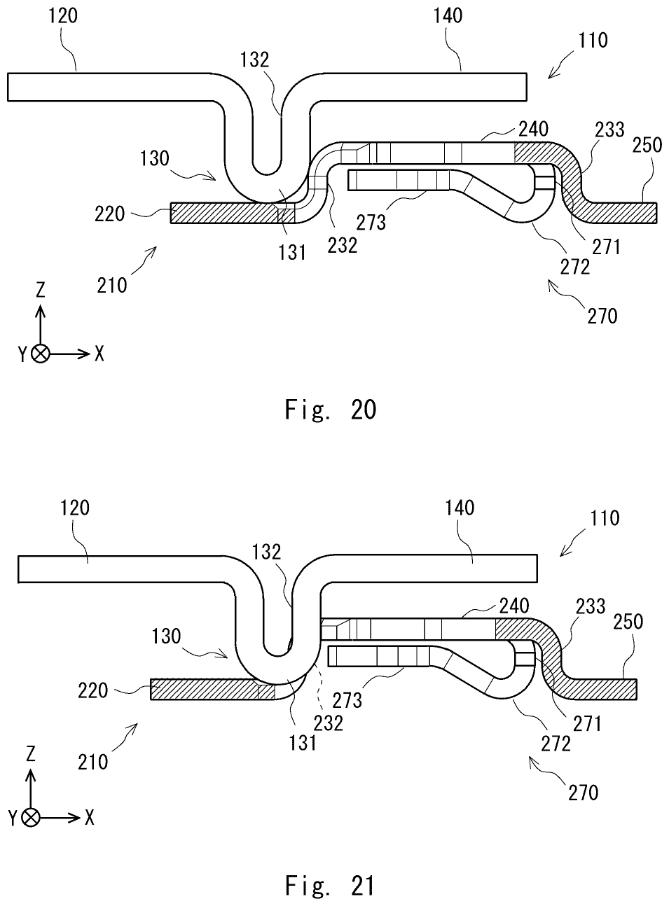

Next, the mating operation of the connector assembly 1 will be described. FIGS. 20 and 21 are partial cross-sectional views illustrating the mating operation between the plug contact 110 and the receptacle contact 210 in the connector assembly 1 according to the first embodiment.

In order to cause the plug connector 100 and the receptacle connector 200 to mate with each other, the plug connector 100 and the receptacle connector 200 are placed opposed to each other in the Z-axis direction.

Next, the plug connector 100 and the receptacle connector 200 are made to become close to each other. For example, the plug connector 100 is moved in the Z-axis negative direction toward the receptacle connector 200. Note that the receptacle connector 200 may be moved in the Z-axis positive direction toward the plug connector 100.

Next, as shown in FIG. 20, in order to make the plug connector 100 and the receptacle connector 200 become close to each other, the projecting part 130 of the plug contact 110 is made to be located above the mounting part 220 of the receptacle contact 210.

Next, as shown in FIG. 21, the projecting part 130 of the plug contact 110 is moved in the X-axis positive direction. The projecting part 130 passes through the slit 280 between the leg part 231 and the leg part 232, and moves through the slit 280 of the guide part 240 in the X-axis positive direction. The plug connector 100 can thus mate with the receptacle connector 200, as shown in FIGS. 18 and 19. When the plug connector 100 is removed from the receptacle connector 200, a procedure opposite to the procedure in the mating operation is performed.

Next, effects of the connector assembly 1 according to this embodiment will be described. In the connector assembly 1 according to this embodiment, the receptacle contact 210 includes the guide part 240 including the slit 280 extending in the X-axis direction, and the contact part 260 and the contact part 270 disposed in the Z-axis negative direction relative to the guide part 240. The guide part 240 includes a function as a guide for moving the plug contact 110 in the X-axis direction along the slit 280. On the other hand, the contact part 260 and the contact part 270 each have a function of coming into contact with the plug contact 110 as a spring piece that is elastically deformed due to the movement of the plug contact 110.

As described above, the connector assembly 1 has a two-stage structure in which the function as a guide when the plug contact 110 is moved and the function as a contact with the plug contact 110 are separated from each other when the plug contact 110 mates with the receptacle contact 210. Therefore, degradation of peeling of plating or the like, which occurs due to the contact between the plug contact 110 and the receptacle contact 210 in the mating operation, can be shared between the guide part 240 and the projection root part 132, and the contact part 260, the contact part 270 and the projection end part 131. Consequently, the degradation of each member can be prevented or reduced, whereby it is possible to improve the contact reliability.

Further, the elastic strength of the guide part 240 and the elastic strength of the contact part 260 and the contact part 270 can be separately controlled. Therefore, the guide part 240 can be formed in such a way that it cannot be easily deformed so that the guide part 240 functions as a guide, and the contact part 260 and the contact part 270 can be formed in such a way that they can be easily deformed so that the contact part 260 and the contact part 270 function as contact parts. That is, it is sufficient that the contact part 260 and the contact part 270 each have a minimum spring restoring force to contact the plug contact 110. Consequently, the contact part 260 and the contact part 270 are able to reduce the friction with the plug contact 110, whereby it is possible to prevent or reduce the degradation and to improve the contact reliability.

Meanwhile, in the connector assembly as disclosed in Patent Literature 1, the part where the plug contact contacts the receptacle contact due to their mating also serves as a guide for the movement of the plug contact and the receptacle contact. Therefore, degradation, such as peeling of plating, which is caused by the contact due to the mating operation, concentrates in one area. Accordingly, degradation of each member is promoted, whereby it is impossible to improve the contact reliability.

### Second Embodiment

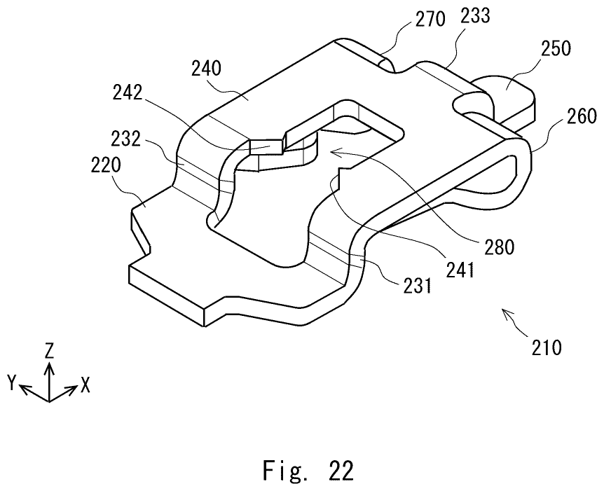

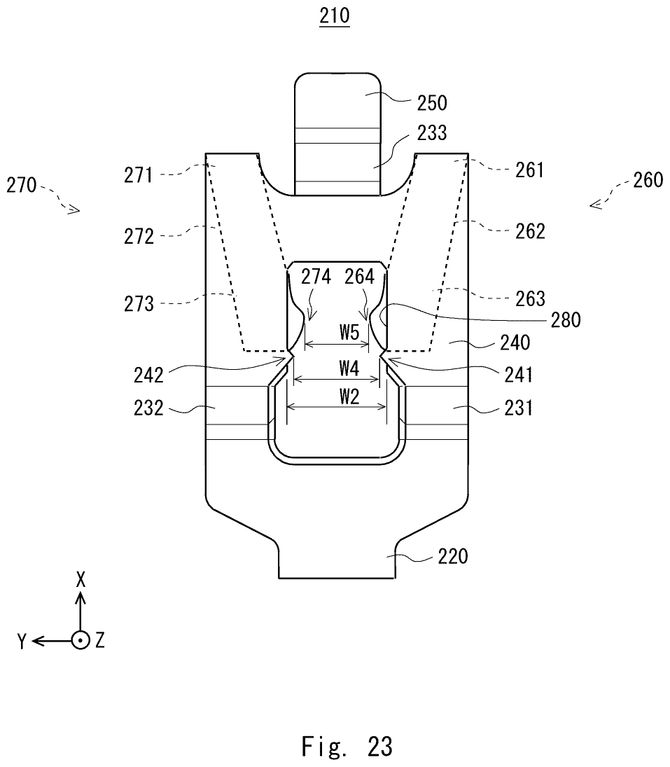

Next, a connector assembly according to a second embodiment will be described. In the connector assembly according to this embodiment, in a guide part 240, projecting parts that narrow the width of a slit 280 are formed in the vicinity of a mating position in the slit 280 in the guide part 240. FIG. 22 is a perspective view illustrating a receptacle contact 210 in a connector assembly 1 according to the second embodiment. FIG. 23 is a plan view illustrating the receptacle contact 210 in the connector assembly 1 according to the second embodiment.

As shown in FIGS. 22 and 23, in the guide part 240, a projecting part 241 and a projecting part 242 that narrow the width of the slit 280 in the Y-axis direction are formed in the vicinity of the mating position in the slit 280. The projecting part 241 projects in the Y-axis positive direction from the edge on the Y-axis negative direction side of the slit 280. The projecting part 242 projects in the Y-axis negative direction from the edge on the Y-axis positive direction side of the slit 280. Therefore, a width W4 which is between the projecting part 241 and the projecting part 242 in the Y-axis direction is narrower than a width W2 of the slit 280 in the Y-axis direction.

That is, (the width W2 of the slit 280)>(the width W4 between the projecting part 241 and the projecting part 242) is satisfied.

A width W3 of a projection root part 132 of a projecting part 130 in the Y-axis direction is greater than the width W4 which is between the projecting part 241 and the projecting part 242 in the Y-axis direction.

That is, (the width W3 of the projection root part 132)>(the width W4 between the projecting part 241 and the projecting part 242) is satisfied.

Therefore, when the plug contact 110 slides along the slit 280 in the X-axis positive direction, the projection root part 132 in the projecting part 130 moves to the mating position passing over the projecting part 241 and the projecting part 242. The other structures and operations are similar to the structures of the first embodiment.

Next, effects of this embodiment will be described. The connector assembly 1 according to this embodiment includes, in the guide part 240, the projecting part 241 and the projecting part 242 that narrow the width of the slit 280. Therefore, in the connector assembly 1, the projection root part 132 in the plug contact 110 passes over the projecting part 241 and the projecting part 242 of the receptacle contact 210, whereby the plug contact 110 mates with the receptacle contact 210. Consequently, it is possible to obtain a feeling of mating such as clicking sensation and thus improve the contact reliability.

On the other hand, the connector assembly as disclosed in Patent Literature 1 does not include any projecting part in a part where a plug contact and a receptacle contact come into contact with each other due to mating thereof. Therefore, it is difficult to obtain a feeling of mating at the time of slide mating, and thus it is possible that they may be half mated. Further, if a projecting part is formed in a part where the plug contact and the receptacle contact come into contact with each other due to the mating thereof in Patent Literature 1, it is possible that a part having a function of making a contact as a spring piece may be excessively deformed.

In the connector assembly 1 according to this embodiment, the projecting part 241 and the projecting part 242 are formed in the guide part 240 that functions as a guide for the movement of the plug contact 110, whereby it is possible to prevent the contact part 260 and the contact part 270 from being excessively deformed. Further, in this embodiment, the elastic strength of the guide part 240 and the elastic strength of the contact part 260 and the contact part 270 can be separately controlled. It is therefore possible to adjust the elastic strengths in such a way that the projecting part 241 and the projecting part 242 of the guide part 240 produce a sufficiently high level of clicking sensation. On the other hand, it is sufficient that the contact part 260 and the contact part 270 have a minimum spring restoring force to come into contact with the plug contact 110. It is therefore possible to achieve both clicking sensation and contact reliability. The other effects of the second embodiment are included in the description of the first embodiment.

### Third Embodiment

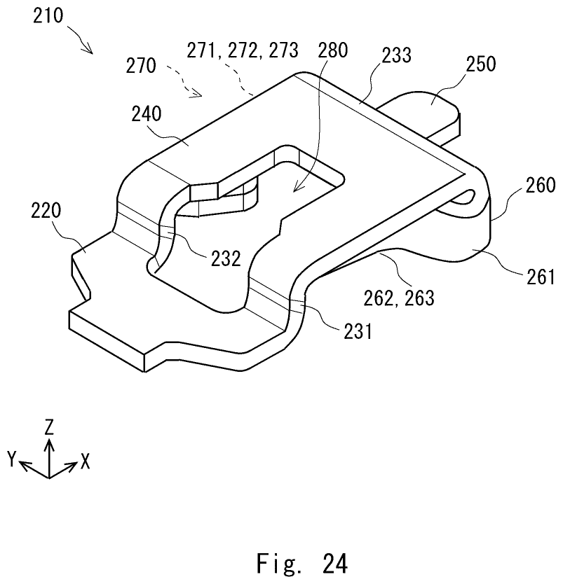

Next, a connector assembly 1 according to a third embodiment will be described. In the connector assembly 1 according to this embodiment, a contact part 260 and a contact part 270 that function as spring pieces in a receptacle contact 210 extend like cantilever beams from a leg part 233. FIG. 24 is a perspective view illustrating the receptacle contact 210 in the connector assembly 1 according to the third embodiment. As shown in FIG. 24, the leg part 233 extends in the Z-axis negative direction from an end part on the X-axis positive direction side of a guide part 240.

The contact part 260 is connected to the end part on the Y-axis negative direction side of the leg part 233. The contact part 260 extends in the X-axis negative direction from the end part on the Y-axis negative direction side of the leg part 233. The contact part 260 includes an extension part 261, a curve part 262, and an extension part 263.

The extension part 261 includes a part extending in the X-axis direction. The end part on the X-axis positive direction side of the extension part 261 is connected to the end part on the Y-axis negative direction side of the leg part 233. The curve part 262 extends in the X-axis direction while it is curved. The end part on the X-axis positive direction side of the curve part 262 is connected to the end part on the X-axis negative direction side of the extension part 261. The extension part 263 includes a part extending in the X-axis direction. The end part on the X-axis positive direction side of the extension part 263 is connected to the end part on the X-axis negative direction side of the curve part 262.

An extension part 271 includes a part extending in the X-axis direction. The end part on the X-axis positive direction side of the extension part 271 is connected to the end part on the Y-axis positive direction side of the leg part 233. A curve part 272 extends in the X-axis direction while it is curved. The end part on the X-axis positive direction side of the curve part 272 is connected to the end part on the X-axis negative direction side of the extension part 271. An extension part 273 includes a part extending in the X-axis direction. The end part on the X-axis positive direction side of the extension part 273 is connected to the end part on the X-axis negative direction side of the curve part 272.

In this embodiment, the contact part 260 and the contact part 270 that function as spring pieces are connected to the end part of the leg part 233 in the Y-axis direction. Accordingly, it is possible to facilitate the oscillation in the Y-axis direction. Therefore, it is possible to easily control elastic deformation of the contact part 260 and the contact part 270 in the Y-axis direction. The other structures, operations, and effects according to the third embodiment are included in the descriptions of the first and second embodiments.

### Fourth Embodiment

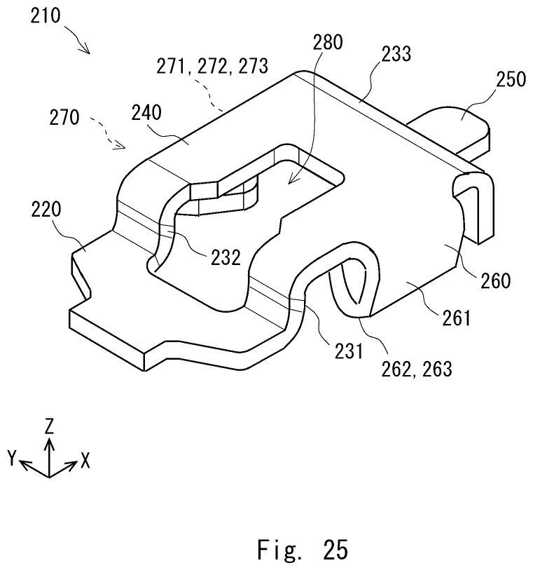

Next, a connector assembly 1 according to a fourth embodiment will be described. In this embodiment, a contact part 260 and a contact part 270 that function as spring pieces in a receptacle contact 210 extend like cantilever beams from the end part on the Y-axis negative direction side of a guide part 240 and the end part on the Y-axis positive direction side of the guide part 240. FIG. 25 is a perspective view illustrating the receptacle contact 210 in the connector assembly 1 according to the fourth embodiment.

As shown in FIG. 25, the contact part 260 is connected to the end part on the Y-axis negative direction side of the guide part 240. The contact part 260 includes an extension part 261, a curve part 262, and an extension part 263. The extension part 261 includes a part extending in the Z-axis direction. The end part on the Z-axis positive direction side of the extension part 261 is connected to the end part on the Y-axis negative direction side of the guide part 240. The curve part 262 extends in the Y-axis direction while it is curved. The end part on the Y-axis negative direction side of the curve part 262 is connected to the end part on the Z-axis negative direction side of the extension part 261. The extension part 263 includes a part extending in the Y-axis direction. The end part on the Y-axis negative direction side of the extension part 263 is connected to the end part on the Y-axis positive direction side of the curve part 262.

The contact part 270 is connected to the end part on the Y-axis positive direction side of the guide part 240. The contact part 270 includes an extension part 271, a curve part 272, and an extension part 273. The extension part 271 includes a part extending in the Z-axis direction. The end part on the Z-axis positive direction side of the extension part 271 is connected to the end part on the

Y-axis positive direction side of the guide part 240. The curve part 272 extends in the Y-axis direction while it is curved. The end part on the Y-axis positive direction side of the curve part 272 is connected to the end part on the Z-axis negative direction side of the extension part 271. The extension part 273 includes a part extending in the Y-axis direction. The end part on the Y-axis positive direction side of the extension part 273 is connected to the end part on the Y-axis negative direction side of the curve part 272.

In this embodiment, the contact part 260 and the contact part 270 that function as spring pieces are connected to the end part of the guide part 240 in the Y-axis direction. Accordingly, it is possible to facilitate the oscillation in the Y-axis direction. Therefore, it is possible to easily control elastic deformation of the contact part 260 and the contact part 270 in the Y-axis direction. The other structures, operations, and effects in the fourth embodiment are included in the description of the first to third embodiments.

### Fifth Embodiment

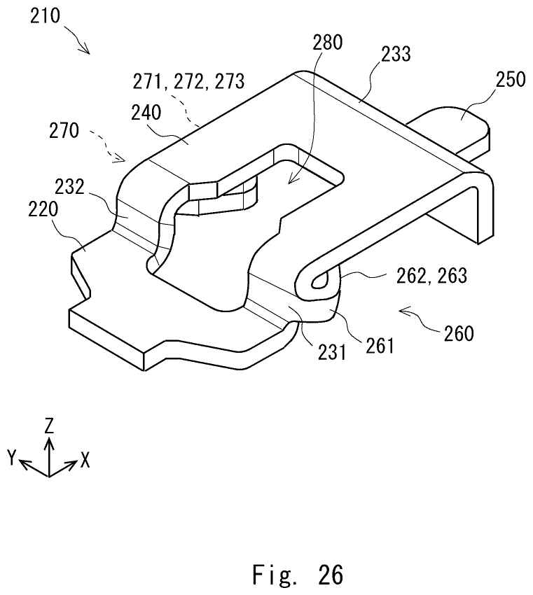

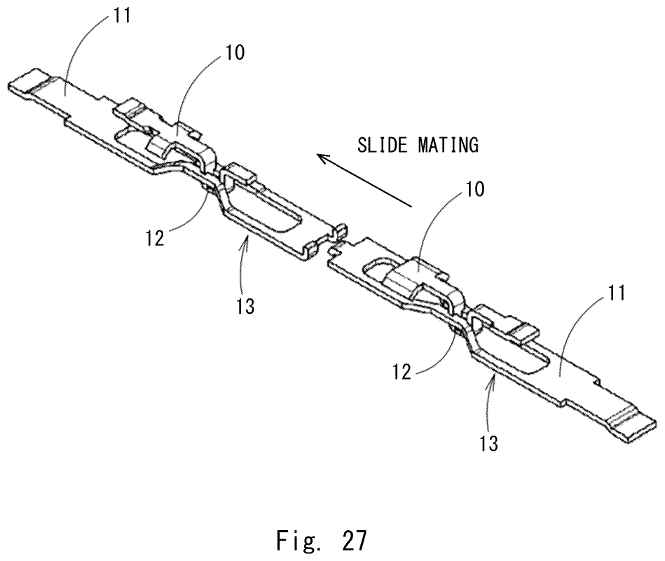

Next, a connector assembly 1 according to a fifth embodiment will be described. In the connector assembly 1 according to this embodiment, a contact part 260 and a contact part 270 that function as spring pieces in a receptacle contact 210 extend like cantilever beams from a leg part 231 and a leg part 232, respectively. FIG. 26 is a perspective view illustrating the receptacle contact 210 in the connector assembly 1 according to the fifth embodiment. As shown in FIG. 26, the leg part 231 and the leg part 232 extend in the Z-axis negative direction from end parts on the X-axis negative direction side of a guide part 240.

The contact part 260 is connected to the end part on the Y-axis negative direction side of the leg part 231. The contact part 260 extends in the X-axis positive direction from the end part on the Y-axis negative direction side of the leg part 231. The contact part 260 includes an extension part 261, a curve part 262, and an extension part 263.

The extension part 261 includes a part extending in the X-axis direction. The end part on the X-axis negative direction side of the extension part 261 is connected to the end part on the Y-axis negative direction side of the leg part 231. The curve part 262 extends in the X-axis positive direction while it is curved. The end part on the X-axis negative direction side of the curve part 262 is connected to the end part on the X-axis positive direction side of the extension part 261. The extension part 263 includes a part extending in the X-axis direction. The end part on the X-axis negative direction side of the extension part 263 is connected to the end part on the X-axis positive direction side of the curve part 262.

An extension part 271 includes a part extending in the X-axis direction. The end part on the X-axis negative direction side of the extension part 271 is connected to the end part on the Y-axis positive direction side of the leg part 232. A curve part 272 extends in the X-axis positive direction while it is curved. The end part on the X-axis negative direction side of the curve part 272 is connected to the end part on the X-axis positive direction side of the extension part 271. An extension part 273 includes a part extending in the X-axis direction. The end part on the X-axis negative direction side of the extension part 273 is connected to the end part on the X-axis positive direction side of the curve part 272.

In this embodiment, the contact part 260 and the contact part 270 that function as spring pieces are respectively connected to the end parts of the leg part 231 and the leg part 232 in the Y-axis direction. Accordingly, it is possible to facilitate the oscillation in the Y-axis direction. Therefore, it is possible to easily control elastic deformation of the contact part 260 and the contact part 270 in the Y-axis direction. The other structures, operations, and effects in the fifth embodiments are included in the description of the first to fourth embodiments.

While the embodiments of the present invention have been described above, the present disclosure includes appropriate variations which do not impair its objects and advantages, and is not limited by the above embodiments. Further, each configuration in the first to fifth embodiments may be combined as appropriate.

The first to fifth embodiments can be combined as desirable by one of ordinary skill in the art.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A connector assembly comprising:
a plug connector including a plurality of plug contacts and a plug housing holding the plurality of plug contacts, the plug connector being mountable on a plug side board; and
a receptacle connector including a plurality of receptacle contacts and a receptacle housing holding the plurality of receptacle contacts, the receptacle connector being mountable on a receptacle side board, wherein
the plug connector and the receptacle connector mate with each other, whereby the respective plug contacts and the respective receptacle contacts come into electrical contact with each other,
each receptacle contact comprises:
a guide part including a slit extending in a first direction parallel to an arrangement plane in which the plurality of receptacle contacts are disposed; and
a contact part that is disposed on one side of a second direction perpendicular to the arrangement plane relative to the guide part, the contact part comprising at least one spring piece that is elastically deformed as each plug contact moves in the first direction along the slit, and
the at least one spring piece comes into contact with each plug contact that has moved to a predetermined mating position in the slit by a spring restoring force.

2. The connector assembly according to claim 1, wherein, the guide part includes a projecting part that narrows a width of the slit formed in the vicinity of the mating position in the slit.

3. The connector assembly according to claim 1, wherein the at least one spring piece is a cantilever beam.

4. The connector assembly according to claim 1, wherein each receptacle contact comprises:
at least one leg part extending in the second direction from the guide part; and
a mounting part that is connected to the leg part and can be soldered onto the receptacle side board.

5. The connector assembly according to claim 1, wherein
the at least one spring piece comprises two spring pieces, and
the two spring pieces:
are disposed in such a way that each plug contact that has moved to the mating position in the slit is inserted between the two spring pieces, and
come into contact with each plug contact that has moved to the mating position in the slit by a spring restoring force.

6. The connector assembly according to claim 5, wherein
the guide part is in a U-shape having the slit extending in the first direction as seen from the second direction,
each receptacle contact comprises:
at least one leg part extending in the second direction from one end part of the guide part in the first direction; and
a mounting part that is connected to the leg part and can be soldered onto the receptacle side board, and
the two spring pieces extend like cantilever beams from another end part of the guide part in the first direction.

7. The connector assembly according to claim 5, wherein
the guide part is in a U-shape having the slit extending in the first direction as seen from the second direction,
each receptacle contact further comprises:
at least one first leg part extending in the second direction from one end part of the guide part in the first direction;
a mounting part that is connected to the first leg part and can be soldered onto the receptacle side board; and
at least one second leg part extending in the second direction from another end part of the guide part in the first direction, and
the two spring pieces extend like cantilever beams from the second leg part.

8. The connector assembly according to claim 5, wherein
the guide part is in a U-shape having the slit extending in the first direction as seen from the second direction,
each receptacle contact comprises:
at least one leg part extending in the second direction from one end part of the guide part in the first direction; and
a mounting part that is connected to the leg part and can be soldered onto the receptacle side board, and
the two spring pieces extend like cantilever beams from one end part and another end part of the guide part in a third direction perpendicular to the first direction and the second direction.

9. The connector assembly according to claim 5, wherein
the guide part is in a U-shape having the slit extending in the first direction as seen from the second direction,
each receptacle contact comprises:
at least one leg part extending in the second direction from one end part of the guide part in the first direction; and
a mounting part that is connected to the leg part and can be soldered onto the receptacle side board, and
the two spring pieces extend like cantilever beams from the leg part.
